(19) United States
(12) Patent Application Publication
(10) Pub. No.: US 2012/0216190 A1
(43) Pub. Date: Aug. 23, 2012

(54) On Demand Scan Engine Deployment

(75) Inventor: James M. Sivak, Laguna Hills, CA (US)

(73) Assignee: McAfee, Inc., Santa Clara, CA (US)

(21) Appl. No.: 13/033,096

(22) Filed: Feb. 23, 2011

(51) Int. Cl. G06F 9/455

(52) U.S. Cl. 718/1

(57) ABSTRACT

Methods, systems, and apparatus, including computer programs encoded on a computer storage medium, for on-demand scan engine deployment. In one aspect, a method includes obtaining parameters of a scheduled scan, the parameters defining computer assets to be scanned and performance requirements. The method includes obtaining historical data describing prior scans that were performed according to similar parameters. The method includes determining performance measures of the prior scans using the historical data. The method includes calculating resource requirements based on the parameters and the performance measures, the resource requirements being requirements that are determined to be needed to meet the performance requirements of the scheduled scan. The method includes determining a number of scan engines required to meet the performance requirements based on the resource scan requirements. The method includes adjusting a number of scan engines in virtual machines so that the number of scan engines are available.

### BACKGROUND

This specification relates to security systems.

Computers are susceptible to infection by malicious programs such as viruses, Trojan horses, worms, and other programs. These malicious programs are collectively referred to as “malware.” A software program can scan a computer to determine if a malware program is present on the computer. A software program can also scan a computer to determine its vulnerability to various malware. In addition, enterprises and governments establish security standards to reduce their security risks, and software programs can scan for compliance to these standards. Collectively, this type of scanning is called vulnerability management

Enterprises typically have hundreds, or even thousands, of computer assets that need to be protected from malware. A computer asset is any computer device that may require protection, such as servers, routers, personal computers, and the like. Vulnerability management scan engines are used to scan the assets to determine their protection status—e.g., whether an asset is protected, at risk, or infected. However, the resources required to scan so many assets can be significant. Security administrators are thus faced with the challenge attempting to maximize the efficient data center resources. Currently, many vulnerability management scan engines may sit idle for periods of time, as the enterprise must have enough resources on hand for the highest demand scans. Thus data center resources are not utilized to their maximum effectiveness.

One possible way to increase efficiency is by the use of virtual scan engines. A data center allocates resources from a pool of shared resources (e.g., processing resources and memory resources) for each virtual scan engine when needed. However, even virtual scan engines must remain deployed so that they will be available when a scan request is issued.

### SUMMARY

In general, one innovative aspect of the subject matter described in this specification can be embodied in methods that include the actions of obtaining, by a data processing apparatus, parameters of a scheduled scan, the parameters defining computer assets to be scanned and one or more performance requirements of the scheduled scan. Actions also include obtaining, by the data processing apparatus, historical data describing prior scans that were performed according to parameters that are similar to the parameters of the scheduled scan. Actions also include determining, by the data processing apparatus, performance measures of the prior scans using the historical data. Actions also include calculating, by the data processing apparatus, resource requirements based on the parameters of the scheduled scan and the performance measures of prior scans, the resource requirements being requirements that are determined to be needed to meet the performance requirements of the scheduled scan. Actions also include determining, by the data processing apparatus, a number of scan engines that are required to meet the performance requirements of the scheduled scan based on the resource scan requirements. Actions also include adjusting, by the data processing apparatus, a number of scan engines in virtual machines so that the number of scan engines is available to perform the scheduled scan.

These and other embodiments may optionally include one or more of the following features. The parameters of the scheduled scan may include a number of assets to scan and a period in which the scheduled scan is to occur and be completed. Adjusting the number of scan engines in virtual machines may include comparing the number of scan engines with a number of currently available scan engines and instantiating scan engines in response to determining that the number of currently available scan engines is less than the required number of scan engines or eliminating scan engines in virtual machines in response to determining that the number of currently available scan engines is greater than the required number so that prior to the performance of the scheduled scan only the number of scan engines are available to perform the scheduled scan. Determining performance measures of the prior scans using the historical data may include determining performance metrics of prior scans that were performed according to similar parameters, each of the performance trends describing a corresponding resource requirement for the prior scans, determining a measure of variability in the prior scans, the measure of variability based on the performance metrics, and determining the number of scan engines is further based on the measure of variability. The measure of variability may be based on a standard deviation calculation. The historical data may include a time of day of the prior scans. Obtaining historical data describing prior scans that were performed according to parameters that are similar to the parameters of the scheduled scan may include obtaining historical data for prior scans having a time of day that matches a time of day of the scheduled scan. Actions may also include performing the scheduled scan on the assets, generating data describing the performance of the scheduled scan, and storing the data as historical data.

Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. The performance requirements of performing a scan can be predicted, and, based on the prediction, only the necessary resources for scanning are allocated, thus improving resource utilization efficiency relative to scan engines that are statically deployed in either a physical or virtual environment. A vulnerability management system can thus dynamically adapt user and scan requirements, and can adapt to changing computer usage. Accordingly, system resources can be more effectively allocated before, during, and after a scan. Efficient allocation of resources can reduce the power and cooling requirements of a data center.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example shared computing environment.

FIG. 2 illustrates an example server utilizing a vulnerability management service.

FIG. 3 is a flowchart of an example process for scan engine deployment.

Like reference numbers and designations in the various drawings indicate like elements.

### DETAILED DESCRIPTION

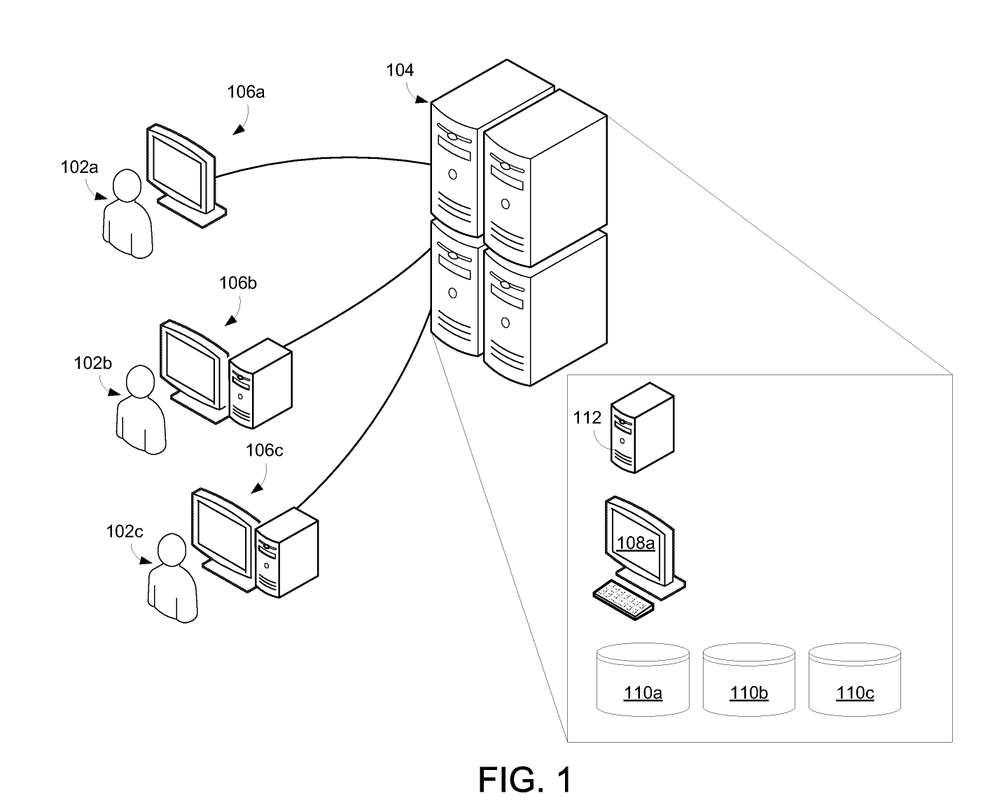

FIG. 1 illustrates an example shared computing environment. Users 102a, 102b, and 102c (collectively users 102) access a server 104 through computer terminals 106a, 106b, and 106c (collectively computer terminals 106). In some implementations, the computer terminals 106 can be computers with independent processors and storage (e.g., 106b and 106c), in other implementations, the computer terminals 106 can be “dumb terminals” without any ability to perform computations independent of the server 104 (e.g., 106a).

In the case of the “dumb terminal,”, the server 104 executes a virtual machine, for example virtual machine 108. Generally, virtual machines 108 are designed to utilize the processing resources of the server 104 on behalf of the users 102. The users 102 access the virtual machine through either a terminal without any independent processing power, or through an application executing on a personal computer. For example, a computer terminal can execute a web browser that presents an interface to a virtual machine. In some implementations, the computer terminals 106 perform processing necessary to secure a communications channel between the computer terminal and the server 104. For example, the computer terminal may encrypt data communications using known secure communication protocols such as the secure socket layer (SSL).

In some implementations, the server 104 provides the computer terminals 106 access to network storage 110a, 110b, 110c (collectively storage 110). For example, the user 102a can be provided with storage 110a which can be accessed by the user's computer terminal 106a as a network drive. The computers 106b and 106c may also have additional storage in the form the network drives. While storage 110a, 110b, and 110c are depicted as distinct storage units, the storage 110 may only be logically distinct and may be on the same physical medium (for example, hard disk, RAID array, etc.)

The server 104 can also include a vulnerability management service 112 that scans assets (including the virtual machines 108, the computer devices 106a, 106b and 106c, and storage 110, which are collectively referred to as “computer assets”) for vulnerabilities and/or compliance. In some implementations, the vulnerability management service 112 can be a virtual machine executing on the server 104 or a process being executed by the server 104. In other implementations, the vulnerability management service 112 can be a separate machine with an independent processor, memory, and storage that accesses the server 104 via a network, and manages the deployed of scan engines in the form of virtual machines.

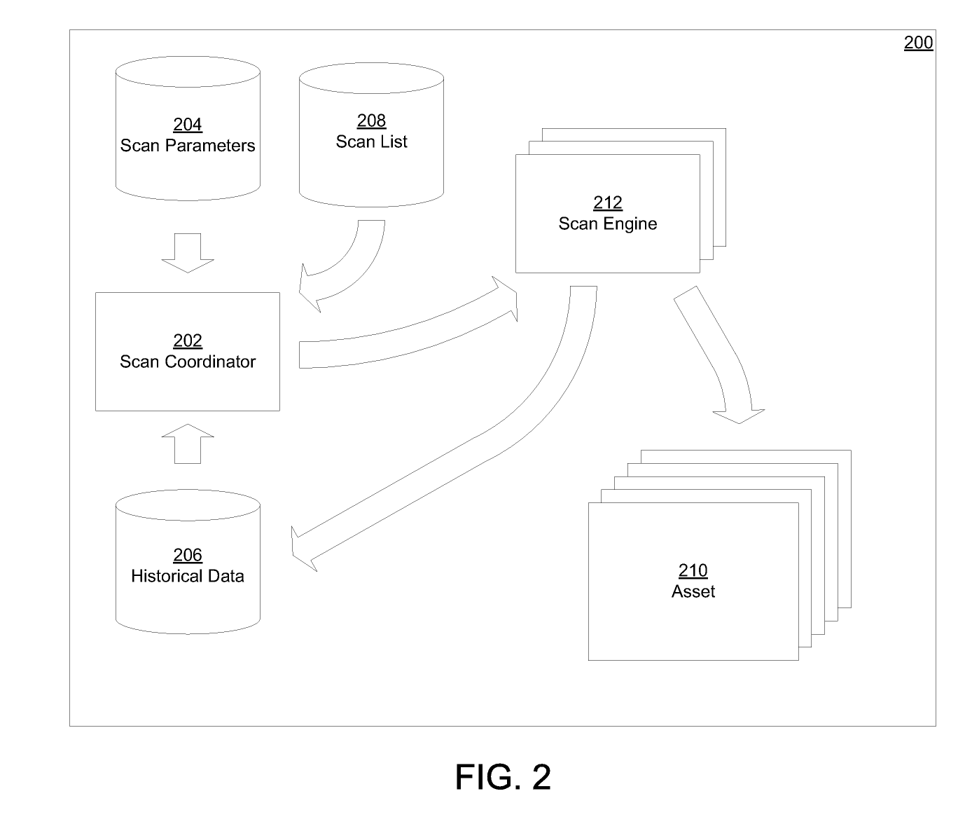

FIG. 2 illustrates an example server utilizing the vulnerability management service. The server 200 includes a scan coordinator 202 that coordinates scan engines 212 to perform assessment scans on one or more assets 210 (for example, the computer assets described above with respect to FIG. 1). In some implementations, the assets 210 are a collection of independent computers connected to the server 200 via a network, and a combination of virtual machines, storage, and independent computers.

The scan engines are instantiated in a virtual environment on as as-needed basis, which will be described in more detail below. Typically, the number of scan engines 212 that are allocated at any one time are of a quantity to handle expected scan requirements within a future time window (e.g., 10 minutes, 20 minutes, etc.). The scan requirements may be, for example, a number of assets to be scanned and a time period within which the scans are to be completed. The requirements may be subject to events internal to an enterprise, and events external to an enterprise. For example, events internal to an enterprise may be a scan schedule, assets to be scanned according to the schedule, and the time required to complete the scheduled scans. Events external to an enterprise include scans in response to a security notice, the announcement of a vulnerability in an operating system, and the like. The external events may be of such nature that the system administrators decide that all assets must be scanned as soon as possible, or that only some assets need to be scanned, and can be scanned at a later time (e.g., after normal working hours, etc.).

In order to coordinate the instantiation and later termination of scan engines 212, the scan coordinator 202 obtains information from a parameter data store 204. The information in the parameter data store 204 describes how the vulnerability management service should scan the system 200. For example, the parameter data stored 204 can define a maximum amount of systems resources (percentage of central processing unit (CPU) utilization or memory) the vulnerability management service can utilize, a minimum amount of system resources that must remain available for other processing, a time period (referred to as a window) during which the scan can take place, etc. In some implementations, the parameter data store 204 can identify the maximum number of scan engines 212 the scan coordinator 202 can create. In other implementations, the number of scan engines 212 available to the scan coordinator 202 is fixed. The parameter data store 204 can be updated in response to internal and external events, as described above.

The scan coordinator 202 obtains a scan list 208 that identifies the assets 210 to be scanned for a scheduled scan. The assets 210 listed for a particular scan can be updated in response to internal and external events, as described above.

The scan coordinator 202 also obtains historical data 206 which describes the performance characteristics of prior scans. The historical data 206 can include, for example, how many assets 210 were scanned, how many scan engines 212 were used to scan the assets 210, the total amount of data that was scanned, and the total number of assets scanned. In some implementations, the historical data 206 also includes information describing the parameters 204 for the previously executed scan.

In some implementations, the historical data 206 includes the performance characteristics of many prior scans. For example, the historical data 206 can include the performance characteristics of the last month of scans, six months of scans, or all scans previously performed. In some implementations, the historical data 206 may include performance characteristics from a fixed number of prior scans, for example, the last five, ten, or twenty scans.

The scan coordinator 202 can predicts changes to the assets 210 based on historical performance trends and metrics, and also based on scheduled changes that are specified by system administrators. For example, if the amount of data per user environment or the number of assets to scan has historically increased by five percent between scans, the scan coordinator 202 can calculate the number of required scan engines 212 based on the assumption that the rate of growth will continue. Similarly, if the amount of time it takes to scan a user environment has historically increased by some amount, the scan coordinator 202 can predict that the time will continue to lengthen at a similar rate.

In implementations where the number of scan engines 212 is fixed, the scan coordinator 202 determines the number of assets 210 that each scan engine can scan within the window. In some implementations, the number of user environments that a scan engine can scan in a window can be calculated using the formula:

$$N = Int ( \frac{W}{G * T} )$$

Where N is the number of assets that a scan engine is expected to be able to scan, W is the duration of the window (the time allocated for scanning), G is the historic growth rate, and T is the time to scan a single user environment. In some implementations, the number of assets N may be reduced to improve the likelihood that the scan can be completed within the window. In some implementations, T may be one mean time to scan a user environment. In other implementations, T may be one or two standard deviations above the mean time to scan a user environment.

The scan coordinator 202 can also predict the amount of time required to scan each asset individually. For example, the estimated time to scan an asset can be calculated as the time it took to scan that asset during the most recent historic scan multiplied by a growth factor as determined by a plurality of the historic scans.

The scan coordinator 202 determines the number of scan engines 212 that are required to complete a scan of the assets 210 based on the parameters 204, the historical data 206, and the scan list 208. In some implementations, the parameters of the previously executed scan are compared to the parameters of a scan that is to be executed. The similarity between the prior parameters and the current parameters 204 is an indicator of the applicability of the historical data. For example, for a current scan to be performed at noon, prior scans also performed at noon may more accurately describe the expected performance characteristics instead of a prior scan performed at midnight. In some implementations, the variability of the scan over time is calculated and retained. The variability can be used to adjust the number of required scan engines.

In some implementations, the scan coordinator 202 takes into account the variability of prior scans when determining the number of required scan engines. If, historically, there has been a large amount of variability in the scans, then more scan engines will be allocated over the minimum number a scan engines that are determined to be required to ensure that the scan is completed according to the parameters. If there has been a small amount of variability, then fewer scan engines will be allocated over the minimum number a scan engines that are determined to be required to ensure that the scan is completed according to the parameters. In some implementations, the variable is measured in terms of a standard deviation derived from historical data 206.

In some implementations, the scan coordinator 202 identifies and ignores performance characteristics for outlier scan engines. Outlier scan engines can be identified by comparing the performance characteristics of scan engines during a particular scan using traditional statistical methods. For example, a scan engine that has performance characteristics more than two standard deviations from the mean performance characteristics can be determined to be an outlier. Other statistical criteria can also be used (e.g. Chauvenet's criterion, Pierce's criterion, etc.).

To illustrate, consider a first example in which the last three scans according to a set of parameters included scanning 2,000 assets, 3,000 assets, and 1,600 assets respectively. The mean number of assets per scan is 2,200 assets/scan and the standard deviation is approximately 721 assets. Therefore, the scan coordinator 202 may determine that scan engines should be deployed sufficient to scan 2,921 assets (the mean 2,200 plus 721) within the window. In a second example, the last three scans included scanning 2,200, 2,400, and 2,300 assets, respectively. In this example, the mean number of assets per scan is 2,300 and the standard deviation is 100. Therefore, the scan coordinator 202 may determine that scan engines 212 sufficient to scan 2,400 assets should be deployed. Despite the lower mean number of assets in the first example, the scan engine 212 prepares for more assets because of the greater variability. Other measures of variability may also be used.

The scan engine 202 can also predict the number of scan engines 212 required based on growth trends. For example, if the last three scans included scanning 1,000 assets, 1,100 assets, and 1,200 assets respectively, the scan engine determines a growth trend of 100 per scan. The scan engine may determine that scan engines sufficient to scan 1,300 assets should be deployed, to account for the consistent growth.

In some implementations, combinations of different calculations can be evaluated to determine the required number of scan engines 202, for example, historical averages, standard deviations, and growth rates, and variability.

The scan coordinator 202 compares the number of required scan engines to the number of scan engines currently available. If the number of scan engines necessary to perform the scan is greater than the number of scan engines currently running then the scan coordinator 202 instantiates additional scan engines until the required number of scan engines are available.

The scan engines 212 scan the assets 210 for vulnerabilities. In some implementations, as the scan engines perform the scan they store performance measures of the scan in the historical data 206. In other implementations, the scan engines report the performance characteristics of the scan to the scan coordinator 202 and the scan coordinator 202 stores the performance characteristics of a scan in the historical data 206. In some implementations, the scan coordinator 202 combines the performance characteristics of multiple scan engines and stores a summary of the performance characteristics in the historical data 206. In some implementations, the scan coordinator 202 stores performance characteristics of individual scan engines and a summary of the performance characteristics.

Once the scan is complete, the scan coordinator 202 determines if it can shut down some or all of the scan engines 212. In some implementations, the scan coordinator 202 determines if another scan is going to be executed within an interval (for example in the next five minutes, thirty minutes, two hours). If another scan is not going to be executed within the interval then the scan coordinator 202 shuts down some or all of the scan engines 212. If another scan is going to be executed within that interval, the scan coordinator 202 does not shut down the scan engines 212. In some implementations, the scan coordinator 202 determines the number of scan engines required to perform the next scan and shuts down any currently running scan engines 212 which are not expected to be required.

Additionally, the scan coordinator 202 may determine a minimum number of scan engines 212 that need to be maintained for immediate and/or unscheduled scanning needs. For example, unscheduled scans (e.g., due to users logging on to a network at various times, due to downloads over the network, etc.) may require a minimum number of scan engines 212 to meet scanning requirements. The scan coordinator 202 may determine, based on historical data, a minimum number of scan engines 212 that need to be available at any one time.

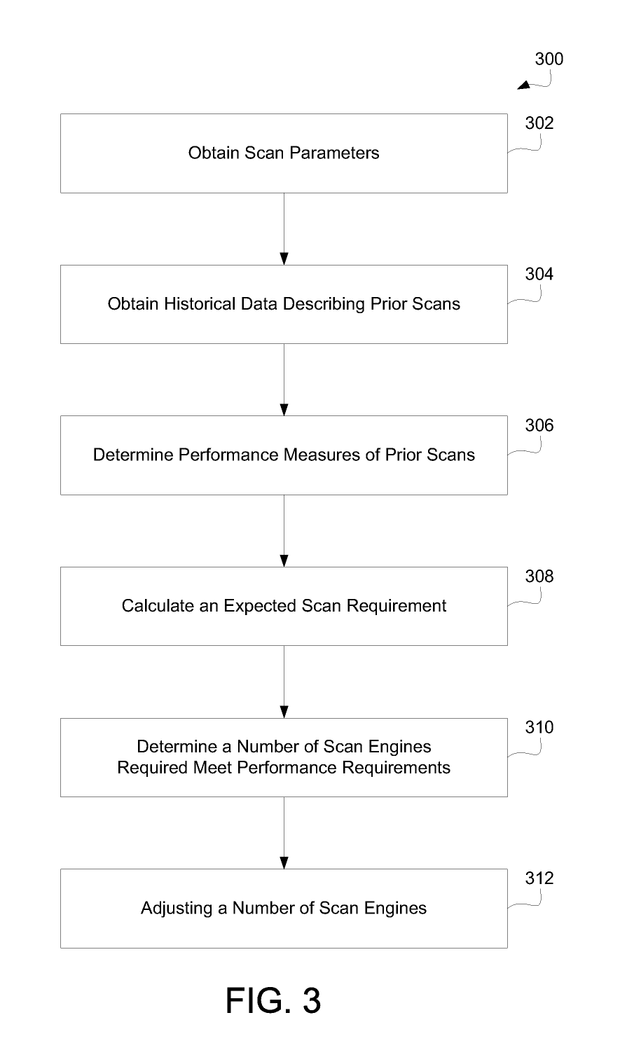

FIG. 3 is a flowchart of an example process for scan engine deployment. The example process 300 can be implemented in a vulnerability management program, e.g., antivirus software, or embodied in software code that runs independently as a separate program with its own computer processes, services, and processes or as part of a dedicated computer.

The process 300 obtains scan parameters (302). In general, the scan parameters define constraints that determine how a scheduled scan should be performed. For example, the scan parameters can define a window during which the scan can be run. The scan parameters can also determine which assets should be scanned.

The process 300 obtains historical data describing prior scans (304). The historic data can be stored, for example, in a database or in performance logs. The historical data includes characteristics of prior scans. The characteristics of prior scans can include information describing the size of the scan, the time of day of the scan, and the duration of the scan. Prior scans are selected have parameters similar to the parameters of the scheduled scan. For example, prior scans can be selected that were performed at a same time of the day as the scheduled scan. The historic data can also include a description of the number of scan engines used in performing the scan.

The process 300 determines performance measures for prior scans (306). Based on the historic data the system calculates performance measures describing the performance of the prior scans. The performance data can include a measure of how much data each scan engine was able to scan within a given time period, the completion time of each scan, and the like.

In some implementations, the process determines performance metrics of the prior scans and determines a measure of variability in the prior scans. For example, the process can determine a standard deviation in the average time to scan an asset or a number of assets.

The process 300 calculates resource requirements (308). The resource requirements are calculated based on the parameters and the performance measures of the prior scans. In some implementations, the expected scan requirements are based on the scan parameters. In some implementations, the expected scan requirements are based on the scan parameters and a rate of growth determined from the historical data.

The process 300 determines a number of scan engines required to meet the performance requirements (310). The number of scan engines can be calculated based on the scan requirements of the scheduled scan and the performance measures of the prior scans. In some implementations, where the process determines the measure of variability, the process adjusts the number of scan engines based on the measure of variability.

The process 300 adjusts a number of scan engines (312). The process adjusts a number of scan engines in a virtual machine so that the number of scan engines are available to perform the scheduled scan.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
obtaining, by a data processing apparatus, parameters of a scheduled scan, the parameters defining computer assets to be scanned and one or more performance requirements of the scheduled scan;
obtaining, by the data processing apparatus, historical data describing prior scans that were performed according to parameters that are similar to the parameters of the scheduled scan;
determining, by the data processing apparatus, performance measures of the prior scans using the historical data;
calculating, by the data processing apparatus, resource requirements based on the parameters of the scheduled scan and the performance measures of prior scans, the resource requirements being requirements that are determined to be needed to meet the performance requirements of the scheduled scan;
determining, by the data processing apparatus, a number of scan engines that are required to meet the performance requirements of the scheduled scan based on the resource scan requirements; and
adjusting, by the data processing apparatus, a number of scan engines in virtual machines so that the number of scan engines are available to perform the scheduled scan.

2. The method of claim 1, wherein the parameters of the scheduled scan include:
a number of assets to scan; and
a period in which the scheduled scan is to occur and be completed.

3. The method of claim 2, wherein determining performance measures of the prior scans using the historical data comprises:
determining performance metrics of prior scans that were performed according to similar parameters, each of the performance trends describing a corresponding resource requirement for the prior scans;
determining a measure of variability in the prior scans, the measure of variability based on the performance metrics; and
determining the number of scan engines is further based on the measure of variability.

4. The method of claim 3, wherein the measure of variable is a standard deviation.

5. The method of claim 1, wherein adjusting the number of scan engines in virtual machines comprises:
comparing the number of scan engines with a number of currently available scan engines;
instantiating scan engines in response to determining that the number of currently available scan engines is less than the required number of scan engines or eliminating scan engines in virtual machines in response to determining that the number of currently available scan engines is greater than the required number so that prior to the performance of the scheduled scan only the number of scan engines are available to perform the scheduled scan.

6. The method of claim 1, wherein:
the historical data includes a time of day of the prior scans; and
obtaining historical data describing prior scans that were performed according to parameters that are similar to the parameters of the scheduled scan comprises obtaining historical data for prior scans having a time of day that matches a time of day of the scheduled scan.

7. The method of claim 1, further comprising:
performing the scheduled scan on the assets;
generating data describing the performance of the scheduled scan; and
storing the data as historical data.

8. A system comprising:
one or more computers; and;
a computer-readable medium coupled to the one or more computers having instructions stored thereon which, when executed by the one or more computers, cause the one or more computers to perform operations comprising:
obtaining, by a data processing apparatus, parameters of a scheduled scan, the parameters defining computer assets to be scanned and one or more performance requirements of the scheduled scan;
obtaining, by the data processing apparatus, historical data describing prior scans that were performed according to parameters that are similar to the parameters of the scheduled scan;
determining, by the data processing apparatus, performance measures of the prior scans using the historical data;
calculating, by the data processing apparatus, resource requirements based on the parameters of the scheduled scan and the performance measures of prior scans, the resource requirements being requirements that are determined to be needed to meet the performance requirements of the scheduled scan;
determining, by the data processing apparatus, a number of scan engines that are required to meet the performance requirements of the scheduled scan based on the resource scan requirements; and
adjusting, by the data processing apparatus, a number of scan engines in virtual machines so that the number of scan engines are available to perform the scheduled scan.

9. The system of claim 8, wherein the parameters of the scheduled scan include:
a number of assets to scan; and
a period in which the scheduled scan is to occur and be completed.

10. The system of claim 9, wherein determining performance measures of the prior scans using the historical data comprises:
determining performance metrics of prior scans that were performed according to similar parameters, each of the performance trends describing a corresponding resource requirement for the prior scans;
determining a measure of variability in the prior scans, the measure of variability based on the performance metrics; and
determining the number of scan engines is further based on the measure of variability.

11. The system of claim 10, wherein the measure of variable is a standard deviation.

12. The system of claim 8, wherein adjusting the number of scan engines in virtual machines comprises:
comparing the number of scan engines with a number of currently available scan engines;
instantiating scan engines in response to determining that the number of currently available scan engines is less than the required number of scan engines or eliminating scan engines in virtual machines in response to determining that the number of currently available scan engines is greater than the required number so that prior to the performance of the scheduled scan only the number of scan engines are available to perform the scheduled scan.

13. The system of claim 8, wherein:
the historical data includes a time of day of the prior scans; and
obtaining historical data describing prior scans that were performed according to parameters that are similar to the parameters of the scheduled scan comprises obtaining historical data for prior scans having a time of day that matches a time of day of the scheduled scan.

14. The system of claim 8, further comprising:
performing the scheduled scan on the assets;
generating data describing the performance of the scheduled scan; and
storing the data as historical data.

15. A computer storage medium encoded with a computer program, the program comprising instructions that when executed by data processing apparatus cause the data processing apparatus to perform operations comprising:
obtaining, by a data processing apparatus, parameters of a scheduled scan, the parameters defining computer assets to be scanned and one or more performance requirements of the scheduled scan;
obtaining, by the data processing apparatus, historical data describing prior scans that were performed according to parameters that are similar to the parameters of the scheduled scan;
determining, by the data processing apparatus, performance measures of the prior scans using the historical data;
calculating, by the data processing apparatus, resource requirements based on the parameters of the scheduled scan and the performance measures of prior scans, the resource requirements being requirements that are determined to be needed to meet the performance requirements of the scheduled scan;
determining, by the data processing apparatus, a number of scan engines that are required to meet the performance requirements of the scheduled scan based on the resource scan requirements; and
adjusting, by the data processing apparatus, a number of scan engines in virtual machines so that the number of scan engines are available to perform the scheduled scan.

16. The medium of claim 15, wherein the parameters of the scheduled scan include:
a number of assets to scan; and
a period in which the scheduled scan is to occur and be completed.

17. The medium of claim 16, wherein determining performance measures of the prior scans using the historical data comprises:
determining performance metrics of prior scans that were performed according to similar parameters, each of the performance trends describing a corresponding resource requirement for the prior scans;
determining a measure of variability in the prior scans, the measure of variability based on the performance metrics; and
determining the number of scan engines is further based on the measure of variability.

18. The medium of claim 17, wherein the measure of variable is a standard deviation.

19. The medium of claim 15, wherein adjusting the number of scan engines in virtual machines comprises:
comparing the number of scan engines with a number of currently available scan engines;
instantiating scan engines in response to determining that the number of currently available scan engines is less than the required number of scan engines or eliminating scan engines in virtual machines in response to determining that the number of currently available scan engines is greater than the required number so that prior to the performance of the scheduled scan only the number of scan engines are available to perform the scheduled scan.

20. The medium of claim 15, wherein:
the historical data includes a time of day of the prior scans; and
obtaining historical data describing prior scans that were performed according to parameters that are similar to the parameters of the scheduled scan comprises obtaining historical data for prior scans having a time of day that matches a time of day of the scheduled scan.

21. The method of claim 15, further comprising:
performing the scheduled scan on the assets;
generating data describing the performance of the scheduled scan; and
storing the data as historical data.
